(19) United States
(12) Patent Application Publication
(10) Pub. No.: US 2024/0429494 A1
(43) Pub. Date: Dec. 26, 2024

(54) PLASMONIC PHOTOELECTRODES FOR PHOTOELECTROCHEMICAL REDOX FLOW BATTERIES

(71) Applicant: BATTELLE SAVANNAH RIVER ALLIANCE, LLC, AIKEN, SC (US)

(72) Inventors: PATRICK A. WARD, AIKEN, SC (US); SIMONA E. HUNYADI MURPH, NORTH AUGUSTA, SC (US); HECTOR COLON-MERCADO, AIKEN, SC (US)

(21) Appl. No.: 18/340,994

(22) Filed: Jun. 26, 2023

(51) Int. Cl. H01M 14/00; H01M 4/90; H01M 8/18

(52) U.S. Cl. CPC H01M 14/005; H01M 4/9091; H01M 8/188

(57) ABSTRACT

Photoelectrodes and photoelectrochemical redox flow batteries incorporating the photoelectrodes are disclosed. The photoelectrodes include a photoactive semiconductor and a plurality of nanoparticles, each of which includes a plurality of edges and/or points, e.g., nanostars, nanopyramids, nanorods, etc.

### FEDERAL RESEARCH STATEMENT

This invention was made with Government support under Contract No. 89303321CEM000080, awarded by the U.S. Department of Energy. The Government has certain rights in the invention.

### BACKGROUND

Energy storage solutions are critical for maintaining the electrical grid and providing reliable power using intermittent renewable energy technologies such as photovoltaics. Moreover, the necessity of grid storage for reliable and dispatchable power intensifies as more photovoltaics are deployed. Various types of energy storage technologies for grid applications exist including pumped hydroelectric storage, lithium ion battery storage, redox flow battery storage, and thermochemical energy storage.

Battery-based technologies have the advantage of rapidly storing and releasing energy and batteries also have the ability to be deployed in a multitude of environments. Lithium ion battery technology is presently the most mature for grid storage applications. Unfortunately, the cost of frequent replacement needs for lithium ion batteries prevent this approach from being an ideal solution for grid storage needs.

Redox flow batteries perform charging and discharging by using a two electrode electrolyte solutions separated by an ion exchange membrane. Each electrolyte solution contains metal ions (active materials) that form a redox pair (also referred to as a redox couple) by which valence is changed by oxidation-reduction.

A solar redox flow battery is a type of a photoelectrochemical cell that can directly transform sunlight into chemical energy, which can then be stored via the redox pairs. Briefly, photons excite an electron from the valence band to the conduction band and generate an electron/hole in a photoactive semiconductor-containing electrode, upon which the electron passes through the electrical circuit and the hole is driven to the surface of the semiconductor. The photoactive semiconductor is in contact with a redox species that is capable of exchanging an electron with the semiconductor. At a positive photoelectrode, at the interface, the hole takes an electron from the redox species, thus oxidizing the redox species. Simultaneously, the electron is released into the electrical circuit that is at a lower potential compared to the valence band hole and is transferred to the other redox species on the other side of the cell via contact with a suitable paired electrode. The net effect is that a redox couple is oxidized at the electrode containing the photoactive semiconductor and another redox couple (with a more negative potential) is reduced at the paired electrode. With a negative photoelectrode, the redox species takes an electron from the semiconductor, thus reducing the redox species at the photoelectrode during the charging cycle. In either case, the oxidized and reduced couples can be stored and later allowed to undergo their reverse (spontaneous) reactions to regenerate the stored energy.

Solar redox flow batteries have been designed, with the first true solar redox flow batteries developed in 2013 (J. Mater. Chem. A, vol. 5, no. 11, pp. 5362-5372, 2017, doi: 10.1039/C7TA00555E). The first of these systems was a dye-sensitized solar cell in tandem with a redox flow battery. The solar cell included ruthenium-based dye-sensitized titanium dioxide (TiO₂) deposited on fluorine-doped tin oxide (FTO) for the photoanode, a lithium ion glass-ceramic separator, and platinized FTO as the cathode. The redox couples of both the solar cell and the battery included iodine (I⁻/I₃⁻) and decamethylferrocene (DMF_{c}⁺/DMF_{c}).

Unfortunately, early work utilized TiO₂ photoelectrodes that were only capable of exciting electrons into the conduction band with the absorption of UV radiation, which is only about 5% of the solar spectrum. Other work has demonstrated the use of cadmium sulfide as a direct semiconductor photoelectrode to charge a vanadium redox flow battery. The current state-of-the-art in this technology has thus been limited to employing low efficiency semiconductor substrates that absorb relatively small portions of the electromagnetic spectrum and have shorter-lived charge separation states.

Needed in the art are composite materials that can improve the efficiency and absorption spectrum of photoactive semiconductor components, and in particular for improvement of solar redox flow batteries.

### SUMMARY

According to one embodiment, disclosed is a photoelectrode that includes a photoactive semiconductor and a plurality of plasmonic nanoparticles in electrical communication with the photoactive semiconductor. Each of the plasmonic nanoparticles has a largest cross-sectional dimension of about 200 nanometers or less and defines a plurality of points and/or edges. The disclosed photoelectrodes can exhibit improved characteristics, e.g., current density (μA/cm²) that is 2 or more times greater than that of a similar photoelectrode that includes spherical plasmonic nanoparticles.

Also disclosed is a redox flow battery that includes a photoelectrode and a second electrode in electrical communication with one another and separated from one another by an ion-exchange membrane. The photoelectrode includes a photoactive semiconductor and a plurality of plasmonic nanoparticles in electrical communication with the photoactive semiconductor. Each of the plasmonic nanoparticles has a largest cross-sectional dimension of about 200 nanometers or less and defines a plurality of well-defined points and/or edges. The redox flow battery also includes a first redox couple in solution configured for contact with the photoelectrode and a second redox couple in solution configured for contact with the second electrode. The redox flow battery can also include a transparent substrate that can allow photons to contact the photoelectrode, e.g., a transparent current collector.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates a photoelectrochemical redox flow battery cell as described herein.

FIG. 2 schematically illustrates one embodiment of a photoelectrode as described herein.

FIG. 3 schematically illustrates another embodiment of a photoelectrode as described herein.

FIG. 4 schematically illustrates a redox flow battery as may incorporate a photoelectrode as described herein.

FIG. 5 presents a transmission electron microscopy (TEM) image of 20 nm gold spheres.

FIG. 6 presents a TEM image of 20 nm gold spheres loaded on a TiO₂ substrate.

FIG. 7 graphically presents the relaxation dynamics with time for gold spheres and gold spheres loaded on a TiO₂ substrate.

FIG. 8 graphically presents the transient absorption spectroscopy data for gold nanospheres pumped at 480 nm.

FIG. 9 graphically presents the transient absorption spectroscopy data for gold nanospheres loaded on a TiO₂ substrate pumped at 480 nm.

FIG. 10 graphically presents the UV/Vis absorption spectra for gold spheres of various sizes either as the spheres only or spheres loaded on a TiO₂ substrate.

FIG. 11 presents a TEM image of 50 nm gold stars.

FIG. 12 graphically compares the current density measurements of 50 nm gold spheres loaded on TiO₂ and 50 nm gold stars loaded on TiO₂ under white light illumination.

FIG. 13 graphically compares the UV/Vis absorption spectra of 50 nm gold spheres and 50 nm gold stars.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to photoelectrodes that can exhibit improved electrochemical characteristics over previously known photoelectrodes and to photoelectrochemical redox flow batteries incorporating the photoelectrodes. Beneficially, the photoelectrodes can be used to directly charge a redox flow battery and can thereby provide for integration of solar energy conversion and storage in one device, which can reduce the cost and footprint associated with renewable energy deployment.

Disclosed photoelectrodes are composite materials that include plasmonic nanoparticles of particular geometries in conjunction with a photoactive semiconductor. Incorporation of the plasmonic nanoparticles in the photoelectrodes can increase the useful wavelength spectrum of incoming light, e.g., visible light, and thereby allow for use of large portions of solar irradiation, which can increase efficiencies (e.g., solar efficiencies) over previously known photoelectrodes. In addition, the photoelectrodes including the plasmonic nanoparticles of shape selective geometries as disclosed herein can exhibit more efficient charge transfer to the semiconductor as compared to previously known photoelectrodes, including as compared to photoelectrodes that incorporate only spherical plasmonic nanoparticles.

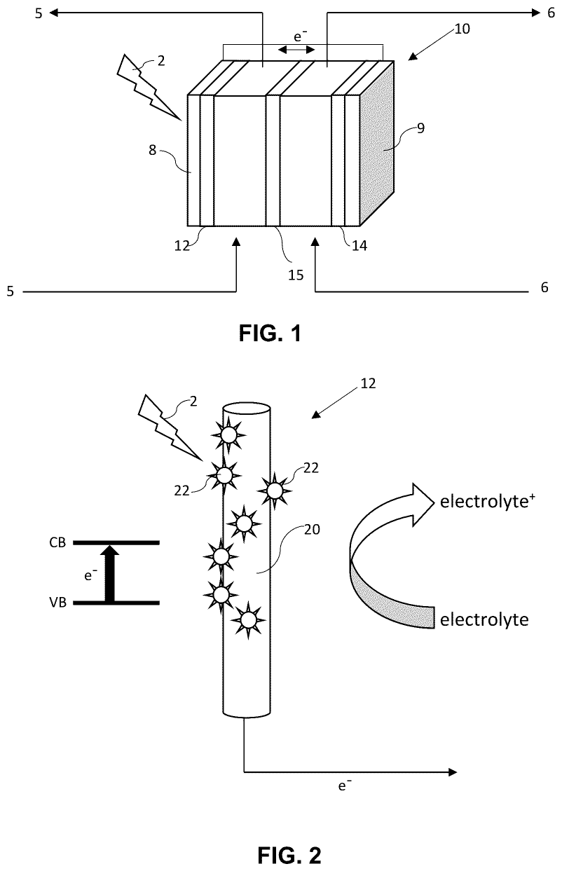

FIG. 1 schematically illustrates a photoelectrochemical redox flow battery cell 10 as may incorporate a photoelectrode as disclosed. As illustrated, the cell 10 includes a photoelectrode 12 and a second electrode 14 separated by an ion-exchange membrane 15. Each electrode 12, 14 is in electrical communication with a current collector 8, 9 that are in electrical communication with one another. The battery cell 10 also includes flow paths 5, 6 along which the two electrolyte solutions can be circulated to contact either side of the ion-exchange membrane and the photoelectrode 12 along flow path 5 or the second electrode 14 along flow path 6. The photoelectrode 12 can be configured for communication with electromagnetic radiation 2, e.g., solar radiation, by which the cell 10 can be charged. For instance, the current collector 8 can be transparent to the wavelengths of interest. However, any arrangement of components can be utilized that can provide for the electromagnetic radiation 2 to be communicated to the photoelectrode 12.

During use, absorbed radiation 2 excites electrons in components of the multicomponent photoelectrode 12 to generate holes and free electrons. The distinguishing advancement in this technology is the demonstration of the ability to use plasmonic nanoparticles of particular geometries to generate charge carriers to enhance the wavelength utilization of the photoelectrode 12 and to increase efficiency of charge transfer in the photoelectrode 12. Upon generation, the free electrons and holes oxidize/reduce the electrolytes in a redox flow cell battery design. The electrons generated from the excitation by the radiation 2 can be transferred to the second electrode 14 to drive the reduction/oxidation of electrolyte molecules this side of a semipermeable membrane 15. The separation of the redox species by the semipermeable membrane 15 effectively stores the electrochemical energy.

FIG. 2 schematically illustrates one embodiment of a photoelectrode 12 of a battery cell. As shown, the photoelectrode 12 includes a semiconductor 20 and a plurality of plasmonic nanoparticles 22 associated with the semiconductor 20.

The plasmonic nanoparticles 22 can generally be formed of one or more plasmonic metals including, but not limited to, gold, silver, platinum, aluminum, copper, or any combination thereof. The plasmonic nanoparticles 22 include those having a geometry that defines one or more points or edges, e.g., non-spherical plasmonic nanoparticles. As utilized herein, the term “edge” with respect to a nanoparticle is intended to refer to a meeting line between two adjacent portions of a particle that has multiple facets or sides, with the adjacent facets or sides defining an identifiable area of the nanoparticle. An edge of a nanoparticle can define a radius of curvature between the two adjacent portions, with that radius of curvature of the edge, when present, being small in relation to the size of the nanoparticle, e.g., on the order of angstroms. A radius of curvature of edges or corners is defined as the radius of a circle that best matches the outer dimensions of a cross sectional cut through the vertex, edge, or corner of the particle. An edge can be a straight edge or can define curvature along the meeting line. Plasmonic nanoparticles can have any number of discrete edges. In one embodiment the nanoparticles can have less than 20, 15, 10, 8, 6, 5, or 4 edges (e.g., 3 edges, 2, edges, 1 edges). In one embodiment the nanoparticles can have more than 2, 3, 4, or 5 edges (e.g., 7, 8, 12, 17 or more edges). In some embodiments the nanoplates can have sharp or rounded corners where two or more edges meet.

As utilized herein, the term “point” with respect to a nanoparticle is intended to refer to an extension or protrusion from the main body of a nanoparticle. A protrusion can extend from the main body of the nanoparticle by a length of about 0.3 nm or more, such as 0.5 nm or more, 1 nm or more, 2 nm or more, 3 nm or more, 4 nm or more, or 5 nm or more, such as from about 0.5 nm to about 20 nm, or from about 1 nm to about 10 nm in some embodiments.

In various embodiments, the plasmonic nanoparticles can define shapes including, without limitation, stars, plates, discs, rods, wires, triangular, pyramidal (including a polygonal base and triangular faces that meet at a common point), bipyramidal (including two pyramids with a common polygonal base), cubes, as well as other crystalline faceted shapes. By way of example, and without limitation, the plasmonic nanoparticles can include nanostars, nanoplates, nanorods, nanocubes, or any combination thereof.

As used herein, the term “nanostar” is intended to refer to a nanoparticle that has a single core section with two or more points or protrusions emitting from the core section of the nanoparticle. These protrusions are generally conical or pyramidal in form, but this is not a requirement of a nanostar.

Nanoplates are characterized by lengths along the three or more principal axes wherein the axial length of two of the principal axes is at least two times greater than the axial length of the shortest principal axis and the shortest principal axial length is less than about 50 nm (e.g., 40 nm, 30 nm, 25 nm, 20 nm, 10 nm, or less) and greater than zero (e.g., 0.5 nm, 1 nm, 5 nm, or more) or any range therein.

A rod shaped nanoparticle can be characterized by lengths along the three principal axes wherein the axial length of one of the principal axes is at least two times greater than the axial length of the other two principal axes, which can be the same or differ from one another.

A cube shaped nanoparticle can generally define six faces. In some embodiments faces of a cube can meet at a sharp edge. In other embodiments the edges where two faces meet can have a radius of curvature. In some embodiments, the faces of the cube can be generally flat. The corners of a nanocube can be sharp or can be rounded with a radius of curvature.

In various embodiments, the core of a plasmonic nanoparticle can have a largest cross-sectional dimension (excluding any protrusions or points) of about 200 nm or less, about 150 nm or less, about 100 nm or less, about 90 nm or less, about 80 nm or less, about 70 nm or less, about 50 nm or less, about 30 nm or less, about 25 nm or less, about 20 nm or less, or about 10 nm or less in some embodiments, for instance from about 1 nm to about 200 nm, from about 2 nm to about 50 nm, from about 3 nm to about 25 nm, or from about 5 nm to about 20 nm in some embodiments.

When a surface of a plasmonic nanoparticle is irradiated by incident radiation 2, e.g., sunlight, conduction electrons are displaced into frequency oscillations which are highly dependent on the external dielectric constant highly tunable with their size and shape. These oscillating electrons, called “surface plasmons,” produce a secondary electric field, which adds to the incident field and increases the efficiency of excitation of semiconductor electrons from the valence band (VB) to the conduction band (CB), as illustrated in FIG. 2. Surprisingly, through utilization of plasmonic nanoparticles that include multiple edges or points the enhancement of the incident electromagnetic field is much greater than that provided by use of nanoparticles that do not define edges or points, e.g., spherical or ovoid nanoparticles. Surprisingly, the addition of plasmonic nanostars to a photoelectrode can increase the current density (μA/cm²) by a factor of 2 or greater as compared to a similar photoelectrode that incorporates spherical plasmonic nanoparticles. For example, a photoelectrode incorporating plasmonic nanoparticles that include edges and/or points can exhibit a current density of about 5 μA/cm² or greater, about 6 μA/cm² or greater, about 7 μA/cm² or greater, about 8 μA/cm² or greater, or about 9 μA/cm² or greater in some embodiments, while under the same charging conditions an identical photoelectrode but for the inclusion of plasmonic nanospheres rather than the multi-edged/multi-pointed nanoparticles as disclosed, will exhibit a current density of 4 μA/cm² or less.

A photoelectrode 12 can include a photoactive semiconductor 20 in electrical communication with the plasmonic nanoparticles 22. In general, any suitable photoactive semiconductor materials may be used, including n- or p-type semiconductor materials.

An n-type semiconductor (e.g., phosphorus, arsenic, antimony; a group V element) is a semiconductor in which electrical conduction is due chiefly to the movement of electrons. In those embodiments in which it is a hole that reacts with the redox couple at the photoelectrode during charging, the semiconductor will generally include an n-type semiconductor, as it has a more significant electron concentration than hole concentration.

A p-type semiconductor (e.g., gallium, indium; a group III element) is a semiconductor in which electrical conduction is due chiefly to the movement of positive holes. In those embodiments in which reduction at the photoelectrode during charging occurs via diving an electron into the solution at the junction between the solution and the photoelectrode to reduce H⁺, the semiconductor can include a p-type semiconductor, as it has a more significant hole concentration than electron concentration.

In one embodiment, the photoactive semiconductor 20 can include at least one metal oxide, such as but not limited to, one or more metal oxides or semiconductor metal oxides, such as titanium oxides, silicon oxides, aluminum oxides, iron oxides, silver oxides, cobalt oxides, chromium oxides, copper oxides, tungsten oxides, zinc oxides, niobium oxides, tantalum oxides, zinc/tin oxides, strontium titanate, and any mixtures thereof. A metal oxide can include oxides, super-oxides or sub-oxides of the metal. A metal oxide can be crystalline or at least partially crystalline. In one embodiment, a photoactive semiconductor can include titanium dioxide (TiO₂), tungsten oxide (WO₃), molybdenum oxide (MoO₃), zinc oxide (ZnO), or any combination thereof.

Photoactive semiconductors can be utilized can encompass any type of a material. For instance, TiO₂ as can be utilized can include anatase TiO₂, rutile TiO₂, or any mix thereof. Likewise, the crystal structure of a photoactive semiconductor is not particularly limited. For instance, WOs as may be encompassed can include monoclinic WO₃, orthorhombic WO₃, or any combination thereof.

In one embodiment, the photoactive semiconductor can include TiO₂. TiO₂ has historically been utilized in formation of photoelectrochemical redox flow batteries, but the band gap of TiO₂ (3.1 eV) is too large for use with approximately 97 percent of the available solar energy. Specifically, TiO₂ absorbs only wave lengths that are shorter than about 400 nanometers (less than 5% of the solar spectrum, and about 97 percent of the terrestrial solar spectrum has wave lengths that are longer than 400 nanometers. However, TiO₂ does have a great advantage of being a material which is not toxic to the general environment and it does not exhibit harmful effects to the environment commonly associated with materials having a natural band gap more closely attuned to the solar spectrum such as, for example, cadmium selenide (CdSe) and gallium arsenide (GaAs). The composite photoelectrodes as disclosed herein can thus in one embodiment enable more widespread utilization of non-toxic TiO₂ in solar redox flow batteries.

The photoactive semiconductor material(s) of a photoelectrode is not limited to any particular photoactive semiconductor materials, however. A particular photoactive semiconductor of choice can depend upon the redox couples of the electrochemical cell. A photoactive semiconductor should have a large enough bandgap to react with a redox couple at the photoelectrode (e.g., VO²⁺/VO₂⁺). However, the conduction band should not be too positive to reduce the redox couple at the counter electrode (e.g., V₃⁺/V₂⁺).

The form of the photoactive semiconductor material of the photoelectrode is likewise not particularly limited. In some embodiments, a photoelectrode can include the photoactive semiconductor in the form of a single substrate. In other embodiments, a photoelectrode can include a plurality of particles, e.g., single crystals or polycrystalline particles, of the semiconductor material(s). By way of example, a photoelectrode can include a plurality of single crystals of photoactive semiconductor material, which can be deposited on an appropriate substrate. When utilized in the form of single particles or crystals, the plasmonic nanoparticles can be decorated on the surface of the photoactive semiconductor particles, e.g., prior to deposition on a substrate or combination with an appropriate electrode binder, or can be deposited in conjunction with the photoactive semiconductor particles so as to ensure electrical communication between the plasmonic nanoparticles and the photoactive semiconductor particles. By way of example, in one embodiment, a photoelectrode that includes a plurality of photoactive semiconductor particles on a substrate and/or retained by use of an electrode binder can be surface decorated with a plurality of plasmonic nanoparticles such that the plasmonic nanoparticles are in electrical communication with the photoactive semiconductor material(s) of the photoelectrode.

A photoactive semiconductor material can include one or more dopants as are known in the art, which can increase the photoactivity (e.g., extend the photoactive zone) of the semiconductor material. A dopant can include, without limitation, one or more of chromium (Cr), vanadium (V), manganese (Mn), copper (Cu), iron (Fe), magnesium (Mg), scandium (Sc), yttrium (Y), niobium (Nb), molybdenum (Mo), ruthenium (Ru), tungsten (W), silver (Ag), lead (Pb), nickel (Ni), rhenium (Re), or any mixtures or combinations containing any one or more thereof.

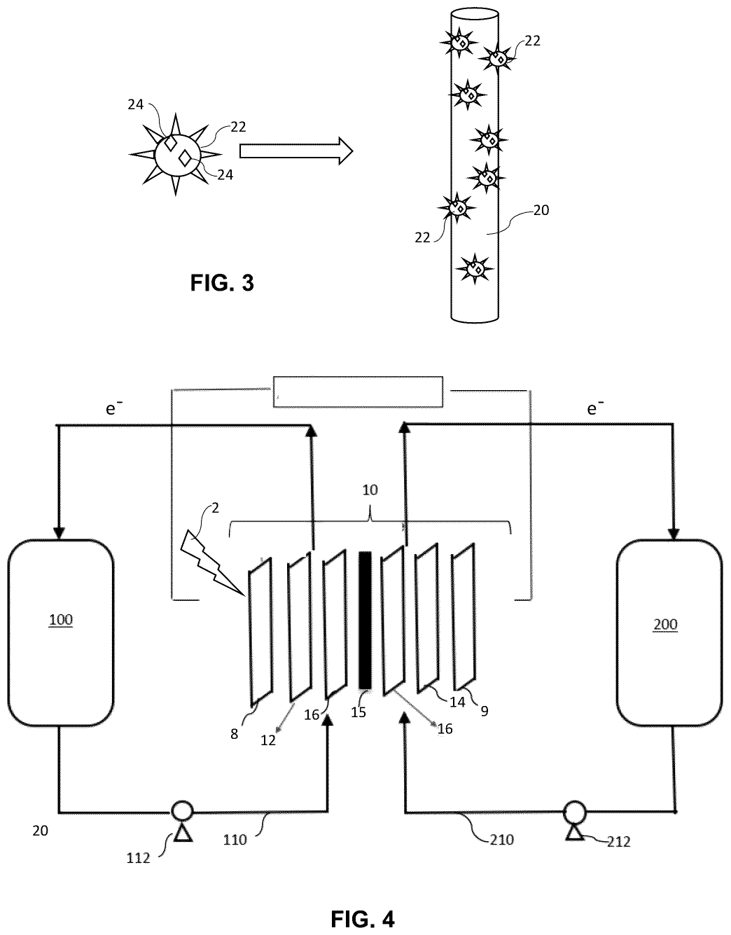

Other components can be included in a photoelectrode to further increase desirable characteristics of the photoelectrode and/or the redox flow battery. For example, and as illustrated in FIG. 3, in one embodiment, the plasmonic nanoparticles can include one or more photoactive dye molecules 24 at a surface to further enhance the solar utilization. The dye molecules can be at a surface of the nanoparticles and/or at a surface of the photoactive semiconductor such that they are in electrical communication with the other components of the electrode. When included, photogenerated electrons from the dye molecule 24 can further increase the solar utilization efficiency from donation of electrons into the semiconductor conduction band (CB) from the dye molecule.

Exemplary dyes can include, without limitation, dyes comprising conjugated conducting polymers, Ru-polypyridyl-complex dyes (e.g., N719 and N3 dyes), hexacyanoferrates (e.g., Prussian blue), metal-free organic dyes including indolic dyes, coumarin-based dyes, triarylamines, carbazoles, fluorenes, thiophenes, porphyrins, oligothiophenes, viologens, etc., or any combination thereof.

One embodiment of a redox flow battery cell 10 that can include a photoelectrode as disclosed is illustrated in FIG. 4. As shown, the cell 10 can be in liquid communication with a first tank 100 that can retain a first electrolyte solution and a second tank 200 that can retain a second electrolyte solution. As indicated in FIG. 4, each side of a cell 10 can include components adjacent the ion exchange membrane 15 as are known in the art including a conductive separator 16, e.g., a porous carbon paper, carbon cloth, carbon felt, or metal cloth (a porous film made of fiber-type metal or a metal film formed on the surface of a polymer fiber cloth), among others.

The cell also includes the photoelectrode 12 and a second, paired electrode 14. The second electrode 14 may be an electrode as is known and may be made of a conductive substrate appropriate for the respective electrolyte solution of the cell (e.g., graphite).

The cell 10 includes current collectors 8, 9 be in electrical communication with the respective electrode 12, 14. The current collectors 8, 9 can provide electrical communication between the cell 10 and an exterior circuit, as shown. The current collector 8 can be located and/or formed of a material that can allow for radiation 2 to contact the photoelectrode 12 during a charging cycle. For instance, in one embodiment, the current collector 8 can include a conductive and transparent substrate such as indium tin oxide, fluorine-doped tin oxide, or aluminum-doped zinc oxide, which can be deposited (e.g., coated) on glass. A currently collector 9 associated with a paired, non-photoactive electrode can be any suitable current collector as is known in the art, e.g., gold-plated copper.

The ion exchange membrane 15 can be an anion exchange membrane or a cation exchange membrane, as is known, the selection of which depending upon the specific characteristics of the cell 10. Examples of suitable ion exchange membranes can include, without limitation, a membrane containing a perfluorocarbon sulfonic acid polymer (e.g., Nafion™, CMV, CMS, AMV, DMV, ASS, DSV, etc.), or a crosslinked polystyrene sulfonate, a nitrogen heterocycle aromatic polymer (e.g., a polybenzimidazole type polymer), etc.

In some embodiments, the ion exchange membrane 15 can be imbibed with a supporting electrolyte, the inclusion or selection of which can depend upon the particular characteristics of the redox flow battery. A supporting electrolyte can include acidic supporting electrolytes, basic supporting electrolytes, as well as neutral species (e.g., water). For instance, the ion exchange membrane 15 can be imbibed with a mineral acid (e.g., a strong inorganic acid) such as hydrochloric acid, nitric acid, fluorosulfonic acid, or sulfuric acid, or a mixture thereof, or a strong organic acid such as acetic acid, formic acid, p-toluene sulfonic acid, or trifluoromethane sulfonic acid or mixtures thereof, as well as mixtures of different types of acids, e.g., a combination of a mineral acid and an organic acid. Other examples of supporting electrolytes that can be imbibed in an ion exchange membrane 15 can include, without limitation, sodium chloride, potassium chloride, sodium hydroxide, potassium hydroxide, sodium sulfide, potassium sulfide, and combinations thereof. By way of example, a supporting electrolyte can include H₂SO₄, HBr, HBr/HCl mixtures, HCl, NaS₂, NaS₂/NaBr mixtures, Br₂ in HBr, Br₂ in H₂SO₄, Br₂ in HBr/H₂SO₄ mixtures, etc. Tetraalkylammonium supporting cations can be imbibed in an ion exchange membrane 15 in one embodiment, with Et₄N⁺ and Bu₄N⁺ being two non-limiting examples. A solution of a tetrafluoroborate (BF⁴⁻), perchlorate (ClO⁴⁻), or hexafluorophosphate (PF⁶⁻), or a combination thereof are additional examples of supporting electrolytes that can be included in an ion exchange membrane 15.

The tanks 100, 200 can be in liquid communication with either side of the ion exchange membrane 15 of the cell 10 by use of conduits 110, 210, pumps 112, 212, valves, control systems, etc. The electrolyte solutions stored in the tanks 100, 200 can be circulated into either side of the cell 10 to contact either side of the ion exchange membrane 15 by pumps 112 and 212, respectively, during charging and discharging.

The electrolyte solutions of a battery can each incorporate one member of a redox pair, as is known. In one particular embodiment, a redox flow battery can be a vanadium redox flow battery (VRB). A VRB includes in a first electrolyte solution a vanadium-based compound in which the vanadium alternates between a +5-valent (pentavalent) and a +4-valent (tetravalent) vanadium such as, for example, (VO₂)₂SO₄, VO(SO₄), or a combination thereof. The second electrolyte solution can include as active material vanadium-based compound in which the vanadium alternates between a +2-valent (divalent) to +3-valent (trivalent) vanadium, such as, for example, VSO₄, V₂ (SO₄)₃, or a combination thereof.

The charge/discharge chemical reactions a VRB can be represented in one embodiment as:

Positive electrode:

VO²⁺+H₂O−e⁻>VO₂⁺+2H⁺ (charge)

VO²⁺+H₂O−e⁻←VO₂⁺+2H⁺ (discharge)
E⁰=+1.00 V vs. standard hydrogen electrode (SHE)

Negative electrode

V³⁺+e⁻→V²⁺ (charge)

V³⁺+e⁻←V²⁺ (discharge)
E⁰=−0.26 V vs. SHE

Overall chemical reaction:

VO²⁺+V³⁺+H₂O→VO₂⁺+2H⁺+V²⁺ (charge)

VO²⁺+V³⁺+H₂O←VO₂⁺+2H⁺+V²⁺ (discharge)
E⁰_{cell}=1.26 V vs. SHE

Of course, the redox flow batteries described herein are not limited to VRB, and other batteries including other redox pairs are encompassed herein. Exemplary redox pairs can include, without limitation, Zn/Br₂; Zn/Fe; Fe/Cr; polysulfide/Br₂; polysulfide/I₂; 9,10-anthraquinone-2,7-disulphonic acid (AQDS)/Br₂; Poly(methyl viologen) (poly (MV))/poly(2,2,6,6-tetramethylpiperidinyloxy-4-yl methacrylate) (poly (TEMPO)); bis-(trimethylammonio) propyl viologen tetrachloride (BTMAP-Vi)/BTMAP-ferrocene dichloride (BTMAP-Fc); 2,6-dihydroxyanthraquinone (2,6-DHAQ)/ferrocyanide; and alloxazine7/8-carboxylic acid (ACA)/ferrocyanide.

By way of example, in one embodiment, a battery can include an electrolyte system that includes as an active anolyte material a ferrocyanide such as [Fe(CN)₆]₃/[Fe(CN)₆]₄ and as an active catholyte material Fe2+ and Fe3+. The catholyte in such a system can include an iron/ligand complex, examples of which can include, without limitation, triethanolamine, diethanolamine, ethanolamine, N,N-bis-(2-hydroxyethyl)-(iminotris)-(hydroxymethyl)-methane and mixtures thereof in which the catholyte may have a ligand-to-iron ratio of from about 3:1 to about 10:1.

The electrolyte solutions can generally include the active material (e.g., vanadium ion, iron ion, etc.) in a concentration of from about 0.5 M to about 10 M. For instance, an electrolyte solution can include an active material in a concentration of at about 0.5M or more, about 0.6M or more, or about 0.7M or more, for instance from about 1M to about 3 M. The paired electrolyte solutions of a redox flow battery can include their respective redox pair active materials in the same concentration as one another or in different concentrations, with the preferred concentrations generally depending upon the particular redox pair to be utilized, the application of the battery, and the presence of any additional additives in the electrolyte solutions.

The electrolyte solutions of a battery can include additives, such as one or more redox flow battery supporting electrolytes as discussed previously. In one embodiment, the electrolyte solutions of a battery can include the supporting electrolyte that has been imbibed in the ion exchange membrane.

An electrolyte solution can include a sulfuric acid supporting electrolyte in one embodiment. For instance, an electrolyte solution can include a mixture of sulfuric acid and water, that is, a sulfuric acid aqueous solution, in conjunction with the active material of the solution, for instance as a solvent. In one embodiment, a mixture of a supporting electrolyte and water, e.g., a sulfuric acid aqueous solution, can include a supporting electrolyte in a concentration of from about 1M to about 5M. The concentration of the supporting electrolyte can be selected in one embodiment so as to provide suitable solubility for the active material of the electrolyte solution. As such, the solution can exhibit desirable ion conductivity and viscosity and can avoid creating an overvoltage issue in the battery.

The present invention may be better understood with reference to the examples, set forth below.

### Example

The underlying electron transfer mechanisms were evaluated using photoelectrochemical ultraviolet/visible spectroscopy and femtosecond transient absorption spectroscopy. The predicted and controlled electron transfer behavior was verified to proceed as theorized which confirms the feasibility of employing these materials as broad band photoelectrodes.

A porous TiO₂ layer was produced on indium tin oxide (ITO) coated slides. Gold nanoparticles (50 nm spheres or 50 nm stars and 20 nm spheres and 20 nm stars) were diffused into the porous TiO₂ layer by allowing the slide to rest in a saturated suspension of gold nanoparticles. Alternatively, gold nanoparticles were grown to the TiO₂ layer by electrophoretic deposition where a voltage was applied to the ITO/TiO₂ slide with respect to a counter electrode while suspended in a concentrated solution of nanoparticles. In some embodiments, PDOT:PSS was used as a hole transport layer.

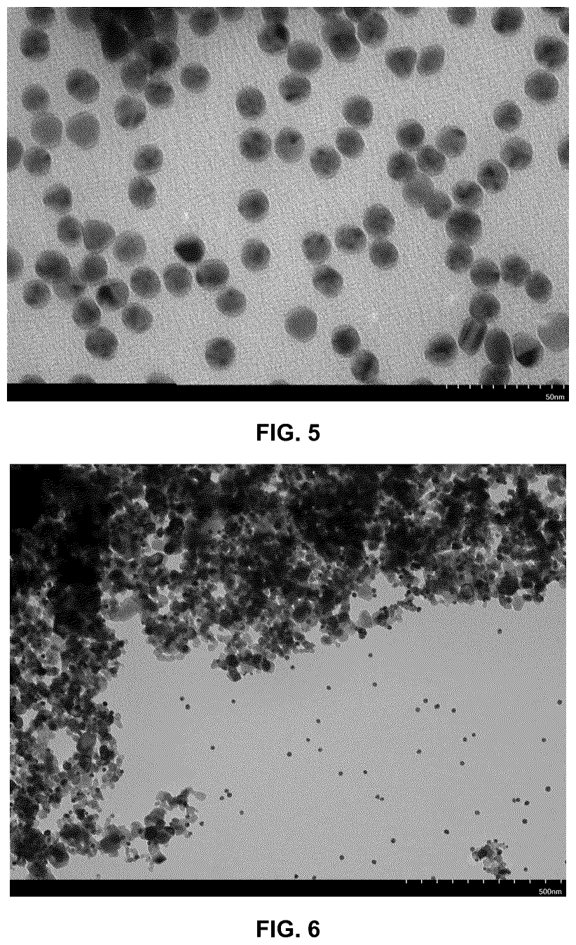

FIG. 5 is a TEM of 20 nm gold nanospheres and FIG. 6 is a TEM of 20 nm gold nanospheres deposited on a TiO₂ substrate.

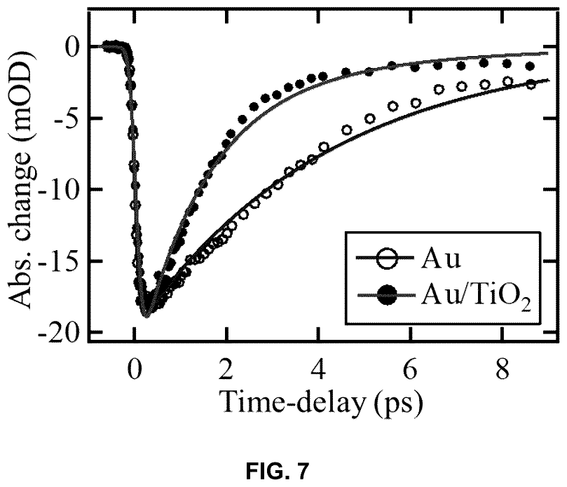

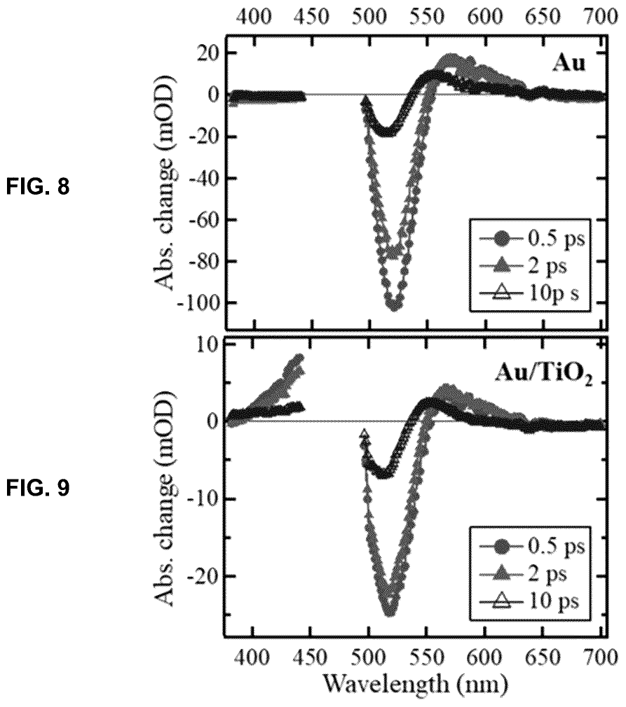

FIG. 7 shows the relaxation dynamics of the gold nanospheres and the gold nanospheres on TiO₂. FIG. 8 and FIG. 9 compare the transient absorption spectroscopy data for the 20 nm gold nanospheres (FIG. 8) and the 20 nm gold nanospheres on TiO₂ (FIG. 9), both pumped at 480 nm.

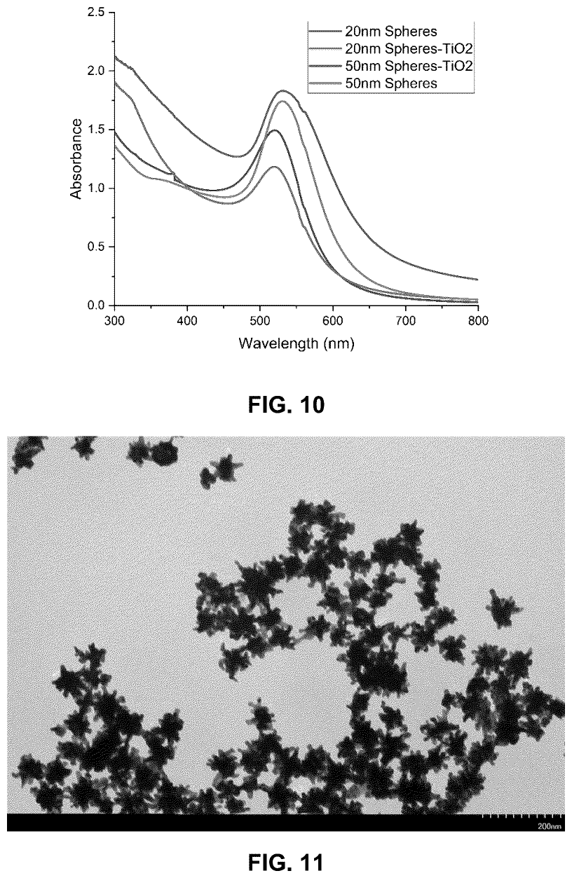

FIG. 10 shows the UV/Vis absorption spectra for 20 nm and 50 nm gold nanospheres, both alone and on TiO₂ substrates.

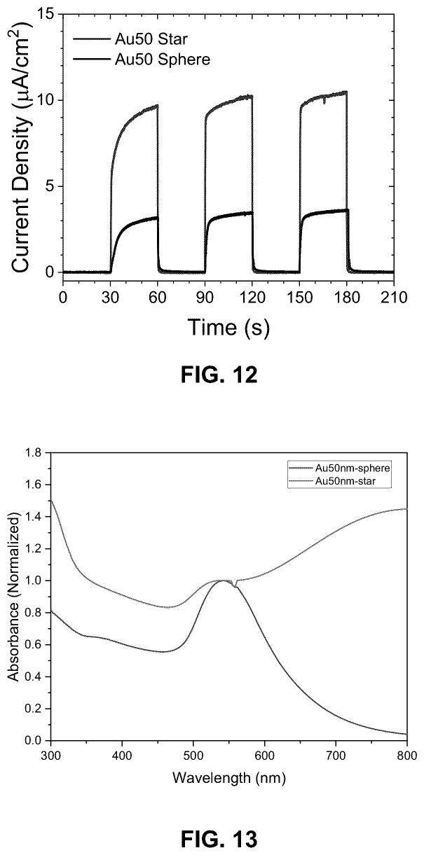

FIG. 11 is a TEM image of 50 nm gold nanostars. FIG. 12 compares the current density of a TiO₂ photoelectrode including 50 nm gold nanostars with the same structure with 50 nm gold nanospheres. FIG. 13 compares the normalized absorbance of the 50 nm gold nanostars with 50 nm gold nanospheres.

While certain embodiments of the disclosed subject matter have been described using specific terms, such description is for illustrative purposes only, and it is to be understood that changes and variations may be made without departing from the spirit or scope of the subject matter.

What is claimed is:

1. A photoelectrode comprising a photoactive semiconductor and a plurality of plasmonic nanoparticles in electrical communication with the photoactive semiconductor, each plasmonic nanoparticle having a largest cross-sectional dimension of about 200 nm or less, each plasmonic nanoparticle defining a plurality of points and/or edges.

2. The photoelectrode of claim 1, wherein the photoactive semiconductor comprises a metal oxide.

3. The photoelectrode of claim 1, wherein the metal oxide comprises titanium dioxide.

4. The photoelectrode of claim 1, wherein the photoelectrode comprises a plurality of semiconductor particles, each semiconductor particle comprising the photoactive semiconductor.

5. The photoelectrode of claim 1, wherein the photoactive semiconductor comprises one or more dopants.

6. The photoelectrode of claim 1, wherein the plasmonic nanoparticles comprise nanostars, nanoplates, nanorods, nanopyramids, nanowires, nanocubes, or any combination thereof.

7. The photoelectrode of claim 1, wherein the plasmonic nanoparticles comprise gold, silver, copper, aluminum, or platinum.

8. The photoelectrode of claim 1, further comprising a photoactive dye.

9. A redox flow battery comprising:
a photoelectrode, the photoelectrode comprising a photoactive semiconductor and a plurality of plasmonic nanoparticles in electrical communication with the photoactive semiconductor, each plasmonic nanoparticle having a largest cross-sectional dimension of about 200 nm or less, each plasmonic nanoparticle defining a plurality of points and/or edges;
a second electrode;
an ion exchange membrane separating the photoelectrode and the second electrode;
a first redox couple in solution configured for contact with the photoelectrode; and
a second redox couple in solution configured for contact with the second electrode.

10. The redox flow battery of claim 9, further comprising a transparent current collector in electrical communication with the photoelectrode.

11. The redox flow battery of claim 9, wherein the ion exchange membrane is a cation exchange membrane.

12. The redox flow battery of claim 9, wherein the ion exchange membrane is an anion exchange membrane.

13. The redox flow batter of claim 9, wherein the photoactive semiconductor comprises titanium dioxide.

14. The redox flow battery of claim 9, wherein the plasmonic nanoparticles comprise nanostars, nanoplates, nanorods, nanopyramids, nanowires, nanocubes, or any combination thereof.

15. The redox flow battery of claim 9, wherein the first redox couple and the second redox couple are independently selected from Zn/Br₂; Zn/Fe; Fe/Cr; polysulfide/Br₂; polysulfide/I₂; 9,10-anthraquinone-2,7-disulphonic acid (AQDS)/Br₂; Poly(methyl viologen) (poly (MV))/poly(2,2,6,6-tetramethylpiperidinyloxy-4-yl methacrylate) (poly (TEMPO)); bis-(trimethylammonio) propyl viologen tetrachloride (BTMAP-Vi)/BTMAP-ferrocene dichloride (BTMAP-Fc); 2,6-dihydroxyanthraquinone (2,6-DHAQ)/ferrocyanide; and alloxazine7/8-carboxylic acid (ACA)/ferrocyanide.

16. The redox flow battery of claim 9, wherein the battery is a vanadium redox flow battery.

17. A method for charging a redox flow battery comprising:
contacting a photoelectrode of the redox flow battery with light, the photoelectrode comprising a photoactive semiconductor and a plurality of plasmonic nanoparticles in electrical communication with the photoactive semiconductor, each plasmonic nanoparticle having a largest cross-sectional dimension of about 200 nm or less, each plasmonic nanoparticle defining a plurality of points and/or edges; and
contacting the photoelectrode with a solution comprising a redox couple, wherein upon the contact, the redox couple is oxidized or reduced;
wherein the photoelectrode exhibits a current density that is about 5 μA/cm² or greater.

18. The method of claim 17, wherein the light comprises sunlight.

19. The method of claim 17, wherein the photoelectrode is a negative photoelectrode.

20. The method of claim 17, wherein the photoelectrode is a positive photoelectrode.
